(19) United States
(12) Patent Application Publication
(10) Pub. No.: US 2007/0290772 A1
(43) Pub. Date: Dec. 20, 2007

(54) Across-trench circuitry for high-speed signal transmission

(75) Inventor: Chun-Yu Lai, Taipei City (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/455,164

(22) Filed: Jun. 15, 2006

(51) Int. Cl. H01P 3/08

(52) U.S. Cl. 333/238

(57) ABSTRACT

An across-trench circuit for high-speed signal transmission applicable to a multi-layer circuit board, such as high-speed digital circuit board, for installing an across-trench signal transmission circuit on the high-speed digital circuit board is disclosed, wherein a pair of coplanar waveguide circuit formed on both sides of signal circuit crossing a trench, so as to reduce ground bounce noise of signal transmission for the high-speed digital circuit board, and thereby increases the quality of transmitting the signals and reduces the ground bounce noise and damage of reflection and interference.

### BACKGROUND OF THE INVENTION

1. Field of the Invention

This invention relates to high-speed digital circuit technology, and more particularly, to an across-trench circuit for high-speed signal transmission on a multi-layer circuit board, such as a high-speed digital circuit board, that can help suppress the bounce noise in the high-speed signals transmitting over the circuit board.

2. Description of Related Art

With the advent of wireless digital communication technologies, such as wireless networking, mobile phones, GPS (Global Positioning System), etc., the design and manufacture of high-speed digital circuit boards that handle digital signals within the gigahertz range is in high demand in the electronics industry. In circuit layout design, high-speed digital circuit boards typically use microstrips (or called striplines) for transmission of digital signals within the range of ultra-high frequencies (UHF), typically from 1 GHz to 10 GHz (gigahertz). It is to be noted that throughout this patent specification, the term “high-speed digital signal” refers to a digital signal with a frequency of from 1 GHz to 10 GHz.

High-speed digital circuits are typically constructed on a multi-layer circuit board which is composed of multiple circuit layers. In the multi-layer circuit board, each signal line is associated with a copper-based reference plane which is used to provide a looped path that can help ensure signal fidelity and prevent EMI (electromagnetic interference) effects. In this multi-layer design, however, it is often required to extend the signal lines across a trench that separates two different plates with different system voltages applied to the reference plane, for example from a 3.3 V plate to a 5.0 V plate. Under this condition, bounce noise would easily occur at the across-trench portion of the signal transmission line, thus resulting in EMI effect that would degrade the fidelity of the high-speed digital signal transmitting therethrough.

One solution to the foregoing problem is to provide an additional number of reference planes within the multi-layer circuit board such that the across-trench design can be avoided. One drawback to this solution, however, is that the increased number of reference planes would make the circuit board more complex in structure and thus more costly to manufacture.

### SUMMARY OF THE INVENTION

It is therefore an objective of this invention to provide an across-trench circuit for high-speed signal transmission on a high-speed digital circuit board that can help suppress bounce noise in the transmitted signal for the purpose of ensuring the fidelity of the transmitted signal.

It is another objective of this invention to provide an across-trench circuit for high-speed signal transmission on a high-speed digital circuit board that can suppress bounce noise in the transmitted signal and ensure the fidelity of the transmitted signal without having to provide additional copper-based reference planes in the circuit board.

The across-trench circuit according to the invention is designed for high-speed signal transmission on a circuit board of the type having a first plate and a second plate separated by a trench, and the structure thereof comprises: (A) a signal transmission line, which extends from the first plate across the trench to the second plate; and (B) a pair of coplanar waveguide striplines, which are provided on both sides of the across-trench portion of the signal transmission line, and whose characteristic impedance is substantially equal to the characteristic impedance of the signal transmission line.

The across-trench circuit of the invention is adapted for use on a multi-layer circuit board, such as a high-speed digital circuit board, for providing a set of across-trench circuit lines on the circuit board that can help suppress the bounce noise in the high-speed signals transmitting over the circuit board.

The across-trench circuit according to the invention is characterized by the provision of a pair of coplanar waveguide striplines on both sides of the across-trench portion of a signal transmission line, such that it can help reduce bounce noise as well as reflection loss and insertion loss in the high-speed digital signal transmitting therethrough, thus assuring the fidelity of the high-speed digital signal being transmitted.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing a perspective view of the across-trench circuit of the invention over a multi-layer circuit board;

FIG. 2 is a schematic diagram showing a top view of the across-trench circuit of the invention over a multi-layer circuit board;

FIG. 3A is a schematic diagram showing a sectional view of a first preferred embodiment of the across-trench circuit of the invention;

FIG. 3B is a schematic diagram showing a sectional view of a second preferred embodiment of the across-trench circuit of the invention;

FIG. 4 is a plot showing the bounce noise characteristic plot of the across-trench circuit of the invention in comparison with a prior art; and

FIG. 5 is a plot showing the reflection loss and insertion loss versus frequency achieved by the across-trench circuit of the invention in comparison with a prior art.

### DETAILED DESCRIPTION OF PREFERRED EMBODIMENTS

The across-trench circuit according to the invention is disclosed in full details by way of preferred embodiments in the following with reference to the accompanying drawings.

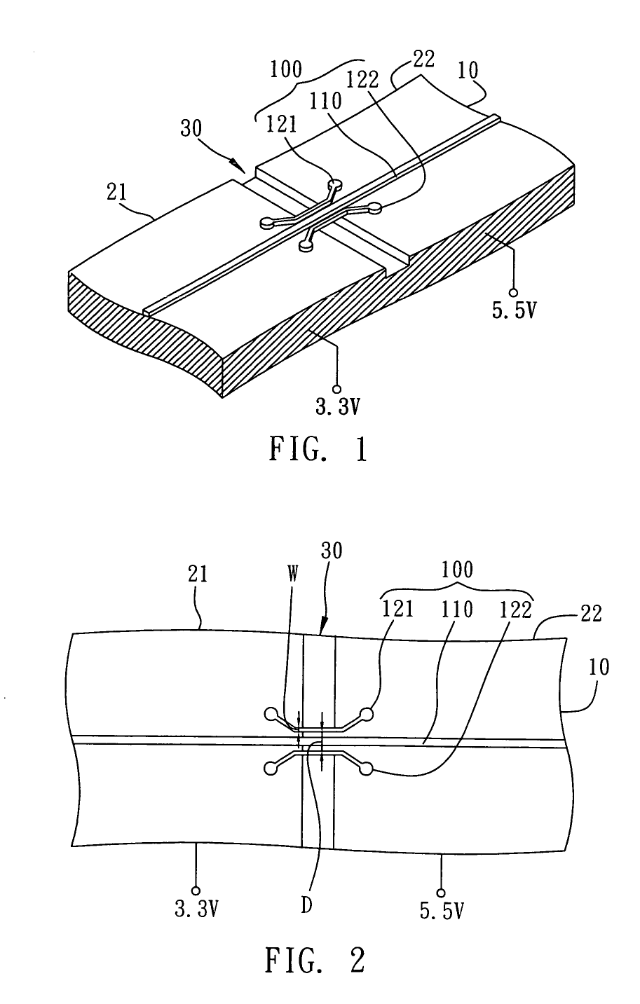

FIG. 1 and FIG. 2 show the application of the across-trench circuit of the invention 100. As shown, the across-trench circuit of the invention 100 is designed for use on a circuit board 10, particularly a multi-layer circuit board such as a high-speed digital circuit board for wireless networking, mobile phone, GPS, or digital TV, to name just a few, where the circuit board 10 is constructed on a multi-layer structure having a first plate 21 and a second plate 22 separated by a trench 30 (It is to be noted that FIG. 1 and FIG. 2 are schematic diagrams intended for demonstrative purpose that shows only those structural parts that are related to the invention; in practice, the circuit board 10 might include many various other components).

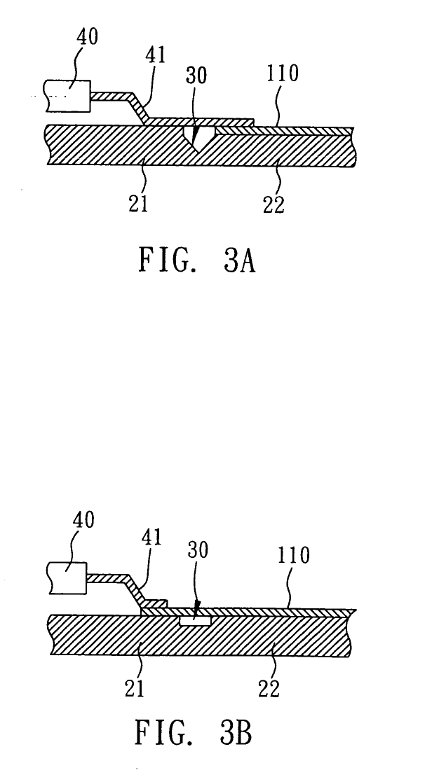

In practical application, as illustrated in FIGS. 3A and 3B, the first plate 21 is used to support an integrated circuit chip 40, such as a high-speed digital processor chip, and which is connected to a system voltage of 3.3 V (volt), whereas the second plate 22 is connected to a 5.0 V system voltage. The across-trench circuit of the invention 100 is used to allow the output signal from one output signal pin 41 of the chip 40 to be transmitted from the first plate 21 across the trench 30 to the second plate 22.

In one application of the invention, the first plate 21 and the second plate 22 of the circuit board 10 are an integrally-formed piece of board, with the trench 30 being a cutout from the circuit board 10.

In other application of the invention, the first plate 21 and the second plate 22 are two separate pieces of plates (not shown), which are separated by a predefined distance (i.e., the trench 30) to form a multi-layered structure.

As shown in FIG. 1 and FIG. 2, the across-trench circuit of the invention 100 comprises a signal transmission line 110 and a pair of coplanar waveguide striplines 121, 122. Firstly, the respective attributes and functions of these constituent components 110, 121, 122 of the across-trench circuit of the invention 100 are described in details in the following.

The signal transmission line 110 is an electrically-conductive line, which is formed in a substantially straight line extending from the first plate 21 across the trench 30 to the second plate 22. The signal transmission line 110 can be embodied in two different ways shown respectively in FIG. 3A and FIG. 3B. By the first preferred embodiment shown in FIG. 3A, the extended output signal pin 41 of the chip 40 is directly utilized to serve as the signal transmission line 110; whereas by the second preferred embodiment shown in FIG. 3B, a microstrip line is formed to serve as the signal transmission line 110. As shown in FIG. 1 and FIG. 2, the signal transmission line 10 extends from the first plate 21 (which operates on 3.3 V system voltage) across the trench 30 to the second plate 22 (which operates on 5.0 V system voltage).

The paired coplanar waveguide striplines 121, 122 are based on a coplanar waveguide (CPW) structure, and as shown in FIG. 1 and FIG. 2, are provided on both sides of the across-trench portion of the signal transmission line 110. For the purpose of minimizing bounce noise, the paired coplanar waveguide striplines 121, 122 are designed in such a manner that its characteristic impedance is substantially equal to the characteristic impedance of the signal transmission line 110. Fundamentally, the characteristic impedance of the paired coplanar waveguide striplines 121, 122 is dependent on line width W and gap distance D (the distance of the gap between the coplanar waveguide striplines 121, 122 and the signal transmission line 10). In practical implementation, the values of the line width W and the gap distance D are obtained by using computer-aided circuit simulation programs, such as Ansoft's HFSS circuit design and simulation program. By using the HESS program, the circuit designer needs just to specify the value of the required characteristic impedance, and the HESS program will output a set of optimized values for the line width W and the gap distance D.

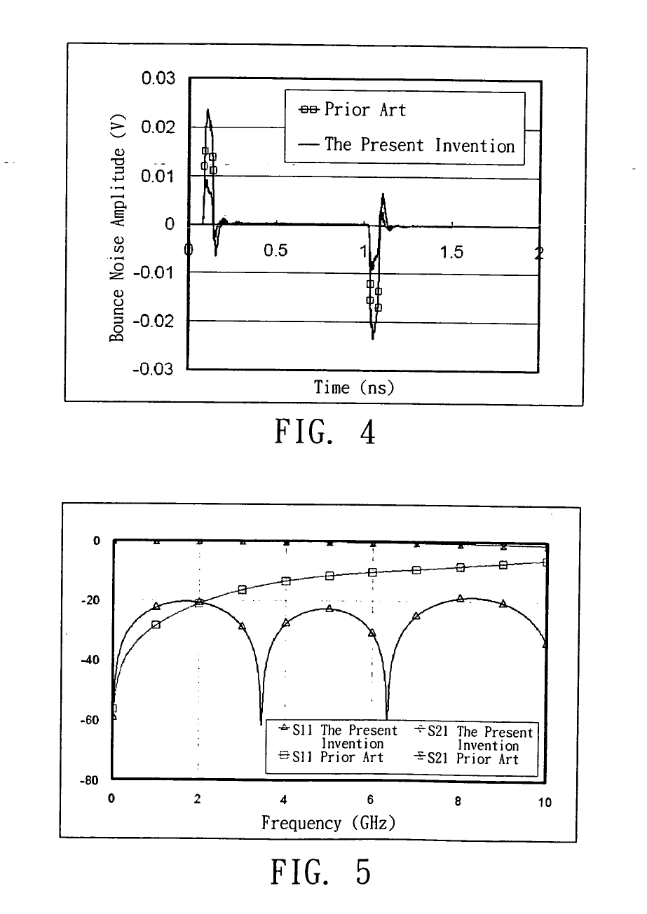

FIG. 4 is a plot showing the bounce noise characteristic of the across-trench circuit of the invention 100 in comparison with the prior art (i.e., a layout design with only the signal transmission line 110 without the coplanar waveguide striplines 121, 122). As shown, the across-trench circuit of the invention 100 is capable of reducing bounce noise to about 40% lower than the prior art, and therefore can effectively assure the fidelity of the high-speed digital signal transmitting therethrough.

In addition, FIG. 5 is a plot showing the reflection loss S11 and insertion loss S21 versus frequency characteristics achieved by the across-trench circuit of the invention in comparison with the prior art. It can be learned from the plot of FIG. 5 that within the frequency range from 2 GHz to 10 GHz, both the reflection loss S11 and insertion loss S21 are significantly lower than those of the prior art.

In conclusion, the invention provides an across-trench circuit for high-speed signal transmission on a high-speed digital circuit board, which is characterized by the provision of a pair of coplanar waveguide striplines on both sides of the across-trench portion of a signal transmission line, such that it can help reduce bounce noise as well as reflection loss and insertion loss in the high-speed digital signal transmitting therethrough, thus assuring the fidelity of the high-speed digital signal being transmitted. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An across-trench circuit for high-speed signal transmission on a multi-layer circuit board of the type having a first plate and a second plate separated by a trench, which comprises:
a signal transmission line, which extends from the first plate across the trench to the second plate; and
a pair of coplanar waveguide striplines, which are provided on both sides of the across-trench portion of the signal transmission line, and whose characteristic impedance is substantially equal to the characteristic impedance of the signal transmission line.

2. The across-trench circuit of claim 1, wherein the multi-layer circuit board is a high-speed digital circuit board.

3. The across-trench circuit of claim 2, wherein the high-speed digital circuit board is wireless networking dedicated circuit board.

4. The across-trench circuit of claim 2, wherein the high-speed digital circuit board is a mobile phone dedicated circuit board.

5. The across-trench circuit of claim 2, wherein the high-speed digital circuit board is a GPS (Global Positioning System) dedicated circuit board.

6. The across-trench circuit of claim 2, wherein the high-speed digital circuit board is a digital TV dedicated circuit board.

7. The across-trench circuit of claim 1, wherein the signal transmission line is an output signal pin of an integrated circuit chip.

8. The across-trench circuit of claim 1, wherein the signal transmission line is a microstrip line.

9. The across-trench circuit of claim 1, wherein the first plate and the second plate are an integrally-formed piece of board formed with a cutaway portion as the trench.

10. The across-trench circuit of claim 1, wherein the first plate and the second plate are two separate pieces of board separated by a predefined distance as the trench.

11. The across-trench circuit of claim 1, wherein the signal transmission line is a straight segment of electrically-conductive line.
